(19) United States
(12) Patent Application Publication
(10) Pub. No.: US 2025/0370220 A1
(43) Pub. Date: Dec. 4, 2025

(54) LENS MINIATURIZATION STRUCTURE

(71) Applicant: GUANGZHOU LUXVISIONS INNOVATION TECHNOLOGY LIMITED, Guangzhou City (CN)

(72) Inventors: Cheng-Te TSENG, Guangzhou City (CN); Shu-Hung LIU, Guangzhou City (CN)

(21) Appl. No.: 19/007,456

(22) Filed: Dec. 31, 2024

(30) Foreign Application Priority Data
May 30, 2024 (CN) 202410691006.1

(51) Int. Cl. G02B 13/00

(52) U.S. Cl. CPC G02B 13/003

(57) ABSTRACT

A lens miniaturization structure, including a first side and a second side located opposite to the first side, the lens miniaturization structure includes a first lens; a lens tube, disposed on the first lens and including an aperture and an opening disposed on a side opposite to the aperture, the aperture facing the first side, the opening facing the second side; and a second lens, disposed in the lens tube and arranged between the aperture and the first lens. An inner diameter of the opening of the lens tube is less than an outer diameter of the first lens.

### BACKGROUND OF THE DISCLOSURE

### Technical Field

The present disclosure relates to a lens miniaturization structure, which is applied in a camera.

### Description of Related Art

A camera module may include a lens component, a filter element, a lens tube, an actuator, a substrate bracket, a sensing element, the processing elements, a storage element, a substrate, a cable, and a firmware stored in the storage element. Therefore, the camera module is a technical field that combines multiple fields, including optics, mechanical, optoelectronics, electronics, and software.

In the field of the mechanical of the camera module, common examples include a lens tube, the actuator, and the substrate bracket, which are closely related to optical purposes. Since the relative position of the lens of the lens component is very important for imaging, the lens tube needs to position the relative position of the lens within acceptable tolerances. The actuator of the camera module with a zoom function positions the lens tube and adjusts the relative position of the lens component and the sensing element.

Since an electronic device such as cell phones, tablet PCs, laptops, smart cameras, monitors, and digital cameras have the demand of being thin, light, short, and light, the restrictions on a length, width, and height of the camera module are getting stricter. The electronics industry is eager to reduce the length, width, and height of the camera module so that the electronic device may be thin, light, and small enough to satisfy consumers. Some thin, light, short, and light electronic devices are required to be equipped with wide-angle camera modules. However, the size of the lens near the sensing element side of the lens component of the wide-angle camera module is generally larger, so the size of the camera module is difficult to reduce.

In view of this, how to reduce the size of the lens tube of the camera module, or even the size of the lens tube of the wide-angle camera module, without degrading the optical image quality and without affecting the optical axis, is one of the current problems that need to be solved.

### SUMMARY OF THE DISCLOSURE

The present disclosure provides a lens miniaturization structure, which may reduce the size of a lens tube of a camera module, or even the size of a lens tube of the wide-angle camera module, without degrading the optical image quality and without affecting the optical axis.

The present disclosure provides a lens miniaturization structure, including a first side and a second side located opposite to the first side, the lens miniaturization structure including: a first lens; a lens tube, disposed on the first lens and including an aperture and an opening disposed on a side opposite to the aperture, the aperture facing the first side, the opening facing the second side; and a second lens, disposed in the lens tube and arranged between the aperture and the first lens; wherein, an inner diameter of the opening of the lens tube is less than an outer diameter of the first lens.

In some embodiments, the inner diameter is a largest inner diameter of the lens tube.

In some embodiments, the first lens includes: a first protrusion edge, disposed protrusively on a side of the first lens towards the first side; the lens tube includes: a concave structure, the first protrusion edge abutting against thereon.

In some embodiments, the first lens includes: a concave structure, disposed concavely on a side of the first lens towards the second side; the lens tube includes: a protrusion edge, abutting against the concave structure of the first lens.

In some embodiments, the lens miniaturization structure, further including: an actuator bracket, abutting against the first lens or the lens tube.

In some embodiments, the actuator bracket abuts against an outer edge of the first lens.

In some embodiments, the actuator bracket includes: a first surface, facing the first side; and a second surface, facing the second side; wherein, the second surface protrudes beyond a surface of the second side of the first lens.

In some embodiments, the lens miniaturization structure, further including: a gasket, sandwiched between the first lens and the second lens.

In some embodiments, the gasket is sheathed in the lens tube.

In some embodiments, the lens miniaturization structure, further including: an adhesive layer, disposed between the first lens and the lens tube.

The present disclosure provides a lens miniaturization structure, including a first side and a second side located opposite to the first side, the lens miniaturization structure including: a first lens, including a main body, including a first protrusion edge and a second protrusion edge, the second protrusion edge disposed protrusively on an edge of the main body, the first protrusion edge disposed adjacent to the second protrusion edge and protruding towards the first side, wherein an outer diameter of the first protrusion edge is less than an outer diameter of the second protrusion edge; an actuator bracket, contacting the second protrusion edge of the first lens to position the first lens; a lens tube, contacting the first protrusion edge of the first lens to position the first lens; and a second lens, disposed in the lens tube, and arranged between the lens tube and the first lens.

In some embodiments, the first lens includes: a third protrusion edge, disposed protrusively on the first protrusion edge towards the first side, the third protrusion edge abutting against the second lens.

In some embodiments, the first lens includes: a third protrusion edge, disposed protrusively on the first protrusion edge towards the first side, the third protrusion edge abutting against an inner surface of the lens tube.

In some embodiments, the actuator bracket includes: a first surface, facing the first side; and a second surface, facing the second side; wherein, the second surface protrudes beyond a surface of the second side of the first lens.

In some embodiments, the lens miniaturization structure, further including: a gasket, sandwiched between the first lens and the second lens.

In some embodiments, the gasket is sheathed in the lens tube.

In some embodiments, the gasket is sandwiched between the second lens and the first protrusion edge.

In some embodiments, the lens miniaturization structure, further including: a third protrusion edge, disposed protrusively on the first lens towards the first side; wherein, the gasket includes: a concave structure, adapted to sheathe the third protrusion edge.

In some embodiments, the lens miniaturization structure, further including: an adhesive layer, disposed between the second protrusion edge and the lens tube.

In some embodiments, the second protrusion edge and the adhesive layer are sandwiched between the actuator bracket and the lens tube.

In summary, the lens miniaturization structure of the present disclosure may reduce the overall diameter of lens tube or even the size of the lens tube of the wide-angle camera module. The lens miniaturization structure of the present disclosure provides a variety of ways to position, stabilize, and protect the structure. Therefore, the lens miniaturization structure of this embodiment may reduce the overall diameter of the lens tube without degrading the optical image quality and without affecting the optical axis. When the lens miniaturization structure is disposed in a cell phone, a tablet PC, a laptop, a smart camera, a monitor, or a digital camera, the lens miniaturization structure may save its internal plane space. Therefore, a cell phone, a tablet PC, a laptop, a smart camera, a monitor, or a digital camera may be much thin, light, short, and light or the extra space may be used to dispose components with other functions.

### BRIEF DESCRIPTION OF THE DRAWINGS

FIG. 1 is a schematic diagram of the camera module from an exploded view in accordance with an embodiment of the present disclosure.

FIG. 2A is a schematic diagram of the lens miniaturization structure in accordance with an embodiment of the present disclosure.

FIG. 2B is a schematic diagram of the lens miniaturization structure in accordance with an embodiment of the present disclosure.

FIG. 2C is a schematic diagram of the lens miniaturization structure in accordance with an embodiment of the present disclosure.

FIG. 3A is a schematic diagram of the lens miniaturization structure in accordance with an embodiment of the present disclosure.

FIG. 3B is a schematic diagram of the lens miniaturization structure in accordance with an embodiment of the present disclosure.

FIG. 3C is a schematic diagram of the lens miniaturization structure in accordance with an embodiment of the present disclosure.

FIG. 3D is a schematic diagram of the lens miniaturization structure in accordance with an embodiment of the present disclosure.

FIG. 3E is a schematic diagram of the lens miniaturization structure in accordance with an embodiment of the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

As used in the present disclosure, terms such as “first”, “second”, and “third” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second”, and “third” does not imply any specific sequence or order.

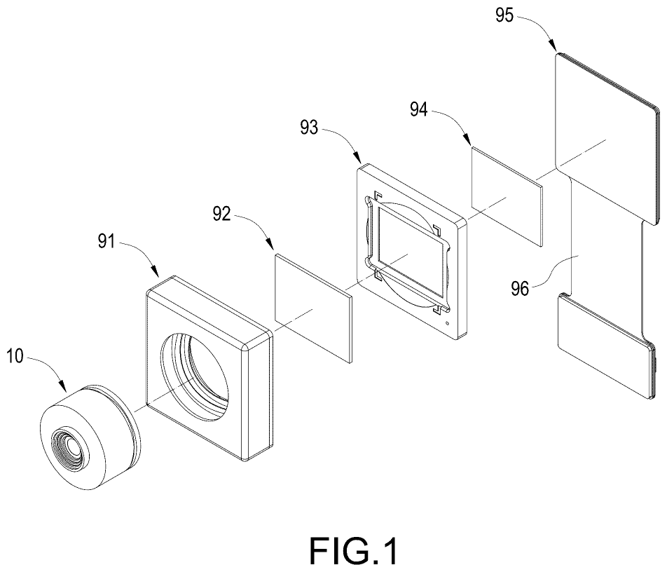

FIG. 1 is a schematic diagram of the camera module from an exploded view in accordance with an embodiment of the present disclosure. Please refer to FIG. 1, a camera module of this embodiment may include a lens tube 10, a lens component, an actuator 91, a filter element 92, a substrate bracket 93, a sensing element 94, a substrate 95, a cable 96 a processing element, a storage element and a firmware stored in a storage element. Therefore, a camera module is a technical field that combines multiple fields, including optics, mechanical, optoelectronics, electronics, and software.

In the field of the optical field of the camera module, common examples include a lens component. The function of a lens component is to collect a light. The lens component collects the light emitted from each point of an object to be photographed on the object side to another point corresponding to each point on the image side. Although from the perspective of the paraxial approximation assumption of geometric optics, a lens component seems to be without technicality. However, in practical design requirements, an object to be photographed, the lens component, and the relative position of the two often do not meet the paraxial approximation assumption. Therefore, in different application situations, different lens components need to be designed to solve the optical aberration problem and reduce the situation where the light emitted from each point of the object to be photographed is not collected to another point corresponding to each point on the image side. For example, in the design of the wide-angle lens component, the light is incident in the lens component from a large angle, which does not meet the paraxial approximation assumption. Therefore, a set of lenses needs to be designed to solve the aberration problem. Aberrations include for example, spherical aberration, coma aberration, astigmatism aberration, field curvature aberration, distortion aberration, and dispersion aberration. The common ways to solve aberrations include, for example, reducing the equivalent aperture, adjusting a position of an aperture, placing the aperture bar at a symmetrical position in the set of lenses, using a plano-convex lens, combining a concave lens and a convex lens, using a free-form lens, using lenses at the aplanatic points, using a symmetrical set of lenses and using a set of lenses with different refractive indexes.

In the field of the optical field of the camera module, common examples include the filter element 92, the filter element 92 may be a coated flat lens or a blue glass. The object to be photographed emits infrared rays in addition to visible light, in practice the object to be photographed emits a continuous spectrum, and the common photoelectric sensing element responds to infrared rays. The filter element 92 prevents infrared rays, which are invisible to the human eye, from being received through the photoelectric sensing element and becoming a noise source in the color image.

In the field of the mechanical of the camera module, common examples include the lens tube 10, the actuator 91, and the substrate bracket 93 which are closely related to optical purposes. Since the relative position of the lens of the lens component is very important for imaging, the lens tube 10 needs to position the relative position of the lens within acceptable tolerances. The actuator 91 of a camera module with zoom function positions the lens tube 10 and adjusts the relative position of the lens component and the sensing element 94. The substrate bracket 93 is configured to position the actuator 91, the filter element 92, and the substrate 95.

In the field of the optoelectronics field of the camera module, common examples include the sensing element 94. When the light of the object to be photographed is collected through the lens component, the light may be imaged on the imaging plane. The sensing element 94 may be placed on the imaging plane to record the light signal. The sensing element 94 may be, for example, a film, a charge-coupled device (CCD), a complementary metal-oxide-semiconductor (CMOS), and other photoelectric sensing elements. CMOS is generally used in a cell phone, a tablet, a laptop, and a digital camera as the sensing element 94. The photoelectric sensing element includes a plurality of pixels. Each pixel generally includes a red light-sensitive sub-pixel (R sub-pixel), a green light-sensitive sub-pixel (G sub-pixel), and a blue light-sensitive sub-pixel (B sub-pixel). The R sub-pixel mainly receives red light, which is generally a continuous electromagnetic spectrum with a long wavelength. The G sub-pixel mainly receives red light, which is generally a continuous electromagnetic spectrum with a medium wavelength. The B sub-pixel mainly receives red light, which is generally a continuous electromagnetic spectrum with a short wavelength. The sensing element 94 may be distributed, for example, 2 million pixels, so the sensing element 94 may get 2 million values of R sub-pixel, 2 million values of G sub-pixel, and 2 million values of B sub-pixel. Therefore, the light signal distribution of the object to be photographed imaged on the sensing element 94 may be recorded. The signal of the light of the sensing element 94 is the digital signal distribution of the values of the R sub-pixel, the values of the G sub-pixel, and the values of the B sub-pixel, and is physically different from the continuous spectrum emitted through the object to be photographed. However, the color reception of the human eyes mainly relies on three types of cones, including short-wavelength cones (S-cones), medium-wavelength cones (M-cones), and long-wavelength cones (L-cones). Therefore, the sensing element 94 may simulate the effect of the color vision on the eye caused by a continuous spectrum by combining the ratio of red light, green light, and blue light only. As a result, when the signal of the light is stored as a digital signal, the signal may be displayed without converting the signal from digital to analog, here is not intended to be limiting.

In the field of the electronics field of the camera module, common examples include a processing element, a storage element, and the substrate 95. In the field of the software field of the camera module, common examples include a firmware stored in the storage element. When the light is converted from an optical signal into an electrical signal through the sensing element 94, the signal may be transmitted to the processing element through the circuit of the substrate 95. After the processing element reads the firmware settings of the storage element, the processing element processes and adjusts the electrical signal. For example, taking into account the human visual characteristics, the values of the R sub-pixel, the values of the G sub-pixel, and the values of the B sub-pixel are converted into luminance (Y), chrominance (U), and chroma (V). The conversion relationship may be a linear conversion and a compression, and may substantially maintain the effect of the image to the human vision. The processing element may also perform other adjustments, for example, lens shading correction, dead pixel correction, gamma correction, color correction, edge enhancement, and image denoising. The processing element may also perform real-time adjustments during shooting, such as automatic exposure, automatic white balance, and automatic focus. Finally, the electrical signal processed through the processing element is transmitted to the motherboard through the substrate 95 and a connector. The electrical signals may be transmitted in the cable 96, for example, through universal serial bus (USB) format or mobile industry processor interface (MIPI) format.

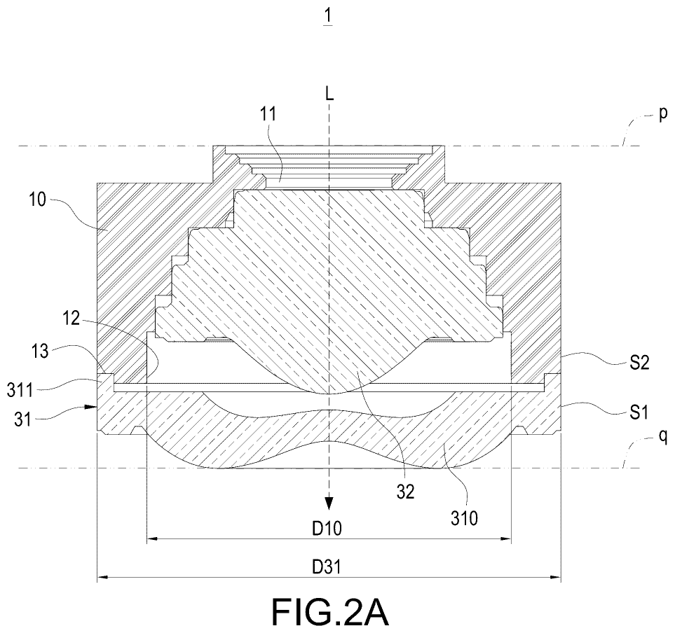

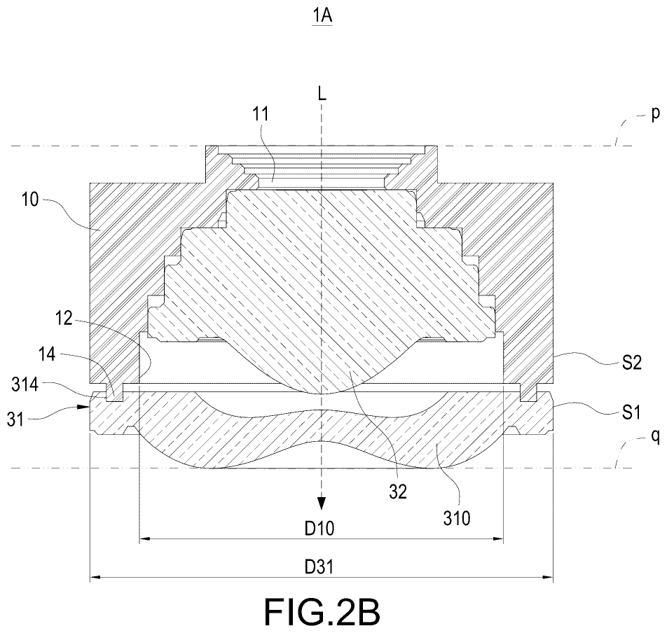

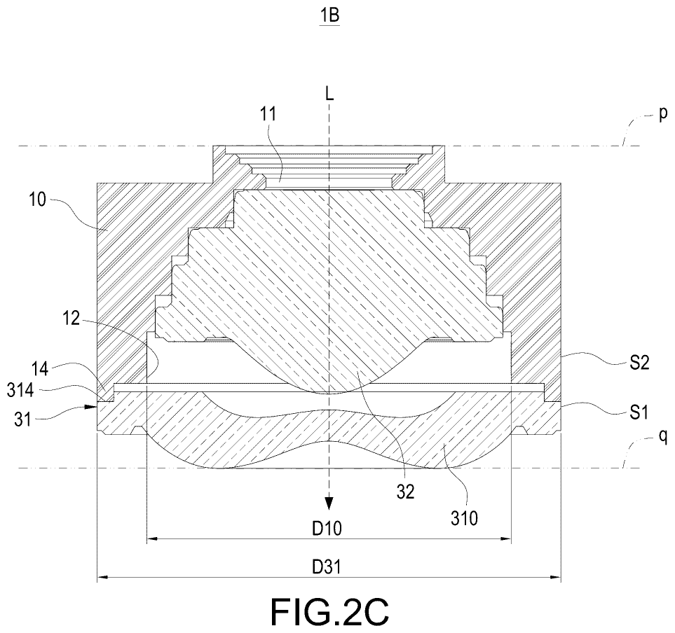

FIG. 2A is a schematic diagram of the lens miniaturization structure in accordance with an embodiment of the present disclosure. Please refer to FIG. 1 and FIG. 2A, a lens miniaturization structure 1 of this embodiment includes a first side p and a second side q located opposite to the first side p. The lens miniaturization structure 1 includes a first lens 31, the lens tube 10, and a second lens 32.

The first side p may face the object to be photographed. The object to be photographed may directly emit the light L or reflect the light L. In other words, the first side p may be a side where the object to be photographed is located, which may also be called the object side.

The second side q is located opposite to the first side p. The second side q may face the sensing element 94. The second side q may receive the light L directly emitted through the object to be photographed at the first side p or the light L reflected through the object to be photographed at the first side p. The object to be photographed is imaged on the second side q. The second side q may also be called an image side. The first side p and the second side q may be the opposite sides of a direction of the optical axis of the lens tube 10.

Please view from the direction facing the FIG. 2A, the first lens 31 may be, for example, a planar lens, a spherical convex lens, a spherical concave lens, a parabolic convex lens, a parabolic concave lens, or a free-form lens, here is not intended to be limiting. Please view from the top to bottom of the FIG. 2A, the shape of the first lens 31 may be a circle, an ellipse, a square, or any curved surface, here is not intended to be limiting. The refractive index of the material of the first lens 31 to visible light is generally different from the refractive index of the medium of the first side p to visible light. The material of the first lens 31 may be, for example, glass or plastic. The medium of the first side p may be, for example, air or water. Here is not intended to be limiting. The first lens 31 may refract the light L, for example, converging the light L, diverging the light L, or reducing optical aberration in combination with other lenses, here is not intended to be limiting.

The lens tube 10 is disposed on the first lens 31 and includes an aperture 11 and an opening 12 disposed on a side opposite to the aperture 11, the aperture 11 facing the first side p, an opening 12 facing the second side q. The material of the lens tube 10 may be, for example, plastic or metal to fix and protect the first lens 31 and the second lens 32, here is not intended to be limiting. The lens tube 10 may be, for example, in a column shape and has two openings. One of the openings may be the aperture 11. The aperture 11 faces the first side p. The aperture 11 faces the first side p, to control the amount of reception of the light L directly emitted through the object to be photographed at the first side p or the light L reflected through the object to be photographed at the first side p and adjust the depth of field of the image. Generally, the larger a diameter of the aperture 11, the more the amount of reception of the light L, and the shorter the depth of field. As a result, the image of the object is clear at the focused position and blurred at the unfocused position. Another opening may be the opening 12. The opening 12 faces the second side q. The light L directly emitted through the object to be photographed at the first side p or the light L reflected through the object to be photographed at the first side p may pass through the aperture 11 and the opening 12 sequentially. In some embodiments, the shape of the section of the lens tube 10 may be a hollow circle, a hollow ellipse, a hollow square, or any hollow curved, here is not intended to be limiting. In some embodiments, the lens tube 10 may telescope and adjust the relative position of the first lens 31 and the second lens 32 to adjust the equivalent focal length. Therefore, the object to be photographed at different distances may be focused. Here is not intended to be limiting. In some embodiments, the lens tube 10 is not telescopic, has a fixed equivalent focal length, and is connected to an actuator bracket 20 to adjust the distance between the lens tube 10 and the sensing element 94. Therefore, the object to be photographed at different distances may be focused. Here is not intended to be limiting.

Please view from the direction facing the FIG. 2A, the second lens 32 is disposed in the lens tube 10 and arranged between the aperture 11 and the first lens 31. In other words, the light L directly emitted through the object to be photographed at the first side p or the light L reflected through the object to be photographed at the first side p may pass through the second lens 32 and the first lens 31 sequentially. The second lens 32 may be, for example, a planar lens, a spherical convex lens, a spherical concave lens, a parabolic convex lens, a parabolic concave lens, a square lens, or a free-form lens, here is not intended to be limiting. Please view from the top to bottom of the FIG. 2A, the shape of the second lens 32 may be a circle, an ellipse, or any curved surface, here is not intended to be limiting. The refractive index of the material of the second lens 32 to visible light is generally different from the refractive index of the medium of the first side p to visible light. The material of the second lens 32 may be, for example, glass or plastic. The medium of the first side p may be, for example, air or water. Here is not intended to be limiting. The second lens 32 may refract the light L, for example, converging the light L, diverging the light L, or reducing optical aberration in combination with the first lens 31, here is not intended to be limiting.

An inner diameter D10 of the opening 12 of the lens tube 10 is less than an outer diameter D31 of the first lens 31. The shape of the opening 12 of the lens tube 10 and the shape of the first lens 31 may be a circle, an ellipse, a square, or any curved surface.

For example, when the shape of the opening 12 of the lens tube 10 and the shape of the first lens 31 are circle, an inner diameter D10 may be a diameter of the opening 12, and an outer diameter D31 may be a diameter of the first lens 31. In other words, when the diameter of the opening 12 less than the diameter of the first lens 31, the first lens 31 is not disposed in the lens tube 10, but disposed outside the lens tube 10. For example, the first lens 31 is arranged below (in the down direction in FIG. 2A) the lens tube 10. In some embodiments, the lens tube 10 may be disposed with multiple lenses of different sizes. The lens tube 10 may be configured with different inner diameter D10 to position multiple lenses of different sizes. In some embodiments, the inner diameter D10 is a largest inner diameter of the lens tube 10. In other words, the first lens 31 is not disposed in the lens tube 10 but disposed outside of the lens tube 10.

For example, when the shape of the opening 12 of the lens tube 10 and the shape of the first lens 31 are ellipses, the inner diameter D10 may be a major axis of the opening 12 and the outer diameter D31 may be a major axis of the first lens 31. In other words, when the major axis of the opening 12 is less than the major axis of the first lens 31, the first lens 31 is not disposed in the lens tube 10 but disposed outside of the lens tube 10. For example, the first lens 31 is arranged below (in the down direction in FIG. 2A) the lens tube 10. In some embodiments, the lens tube 10 may be disposed with multiple lenses of different sizes. The lens tube 10 may be configured with different the inner diameter D10 to position multiple lenses of different sizes. In some embodiments, the inner diameter D10 is a largest inner diameter of the lens tube 10. In other words, the first lens 31 is not disposed in the lens tube 10 but disposed outside of the lens tube 10. For example, when the shape of the opening 12 of the lens tube 10 and the shape of the first lens 31 are square, the inner diameter D10 may be a side length of the opening 12, and the outer diameter D31 may be a side length of the first lens 31. In other words, when the side length of the opening 12 is less than the side length of the first lens 31, the first lens 31 is not disposed in the lens tube 10 but disposed outside of the lens tube 10. For example, the first lens 31 is arranged below (in the down direction in FIG. 2A) the lens tube 10. In some embodiments, the lens tube 10 may be disposed with multiple lenses of different sizes. The lens tube 10 may be configured with different inner diameter D10 to position multiple lenses of different sizes. In some embodiments, the inner diameter D10 is a largest inner diameter of the lens tube 10. In other words, the first lens 31 is not disposed in the lens tube 10 but disposed outside of the lens tube 10. As a result, the overall diameter of the lens tube 10 may be reduced.

In some embodiments, the first lens 31 includes a first protrusion edge 311 disposed protrusively on a side of the first lens 31 towards the first side p. The lens tube 10 includes a concave structure 13. The first protrusion edge 311 abutting against thereon. The shape of the first protrusion edge 311 may be a protruding ring, a protruding circle ring, a protruding ellipse ring, a protruding square column, a protruding rectangular column, or a protruding cylinder. The first protrusion edge 311 is disposed protrusively on a side of the first lens 31 towards the lens tube 10. The shape of the concave structure 13 corresponds to the shape of the first protrusion edge 311. The shape of the concave structure 13 may be a concave ring-shaped structure, a concave circle ring-shaped structure, a concave ellipse ring-shaped structure, a concave square column-shaped structure, a concave rectangular column-shaped structure, or a concave cylindrical-shaped structure. The concave structure 13 is disposed concavely on a side of the lens tube 10. The first protrusion edge 311 may abut against the concave structure 13 to position the relative position of the first lens 31 and the lens tube 10 to facilitate imaging.

In summary, the lens miniaturization structure 1 of this embodiment may reduce the overall diameter of lens tube 10, for example, the size in the left and right directions in FIG. 2A, or even the size of the lens tube of the wide-angle camera module, without degrading the optical image quality and without affecting the optical axis. When the lens miniaturization structure 1 is disposed in a cell phone, a tablet PC, a laptop, a smart camera, a monitor, or a digital camera, the lens miniaturization structure 1 may save its internal plane space. Therefore, a cell phone, a tablet PC, a laptop, a smart camera, a monitor, or a digital camera may be thin, light, short, and light or the extra space may be used to be disposed components with other functions.

FIG. 2B is a schematic diagram of the lens miniaturization structure in accordance with an embodiment of the present disclosure. Please refer to FIG. 2B, the lens miniaturization structure 1A in FIG. 2B is similar to the lens miniaturization structure 1 in FIG. 2A. The difference is that the first lens 31 of the lens miniaturization structure 1A further includes the concave structure 314 disposed concavely on a side of the first lens 31 towards the second side q and the lens tube 10 includes a protrusion edge 14 abutting against the concave structure 314 of the first lens 31. That is different from the first lens 31 of the lens miniaturization structure 1 in FIG. 2A includes the first protrusion edge 311 is disposed protrusively on a side of the first lens 31 towards the first side p, the lens tube 10 includes the concave structure 13, the first protrusion edge 311 abutting against thereon. Here is not intended to be limiting, in some embodiments, the first lens 31 of the lens miniaturization structure 1A may include the first protrusion edge 311 is disposed protrusively on a side of the first lens 31 towards the first side p, the lens tube 10 includes the concave structure 13, the first protrusion edge 311 abutting against thereon. The shape of the protrusion edge 14 may be a protruding ring, a protruding circle ring, a protruding ellipse ring, a protruding square column, a protruding rectangular column, or a protruding cylinder. The protrusion edge 14 is disposed protrusively on a side of the lens tube 10 towards the lens tube 10. The shape of the concave structure 314 corresponds to the shape of the first protrusion edge 311. The shape of the concave structure 13 may be a concave ring-shaped structure, a concave circle ring-shaped structure, a concave ellipse ring-shaped structure, a concave square column-shaped structure, a concave rectangular column-shaped structure, or a concave cylindrical-shaped structure. The concave structure 13 is disposed concavely on a side of the first lens 31. The protrusion edge 14 may abut against the concave structure 314 to position the relative position of the first lens 31 and the lens tube 10 to facilitate imaging.

FIG. 2C is a schematic diagram of the lens miniaturization structure in accordance with an embodiment of the present disclosure. Please refer to FIG. 2C, the lens miniaturization structure 1B in FIG. 2C is similar to the lens miniaturization structure 1A in FIG. 2B. The difference is that the protrusion edge 14 is disposed on an outer edge of the lens tube 10, and the concave structure 314 is disposed on the outer edge of the first lens 31. As a result, the way to position the first lens 31 and the lens tube 10 may be increased.

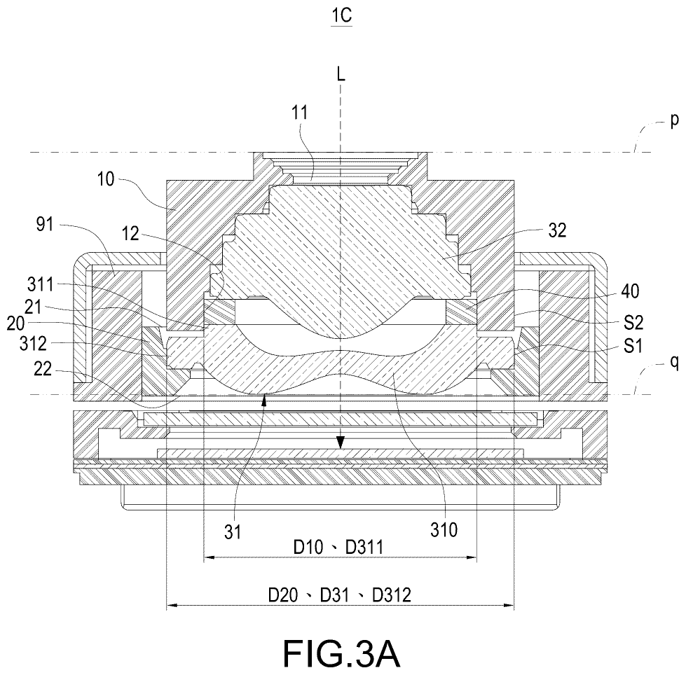

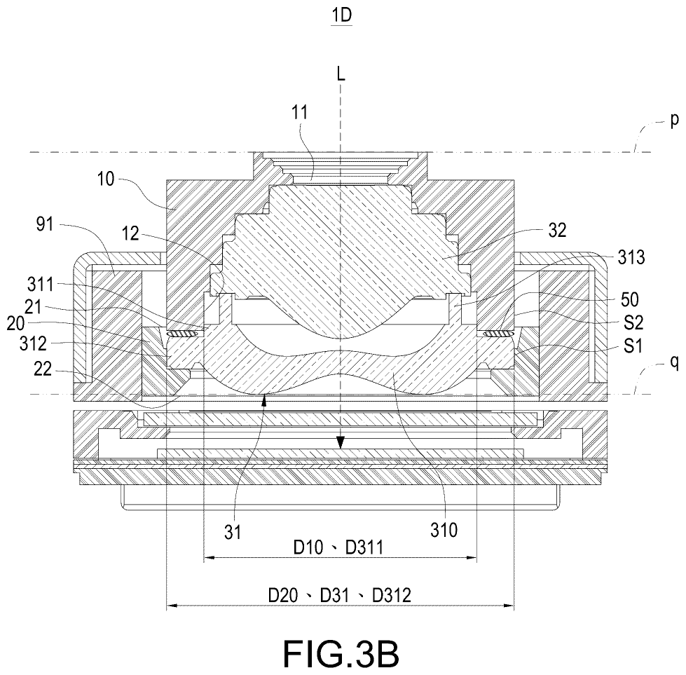

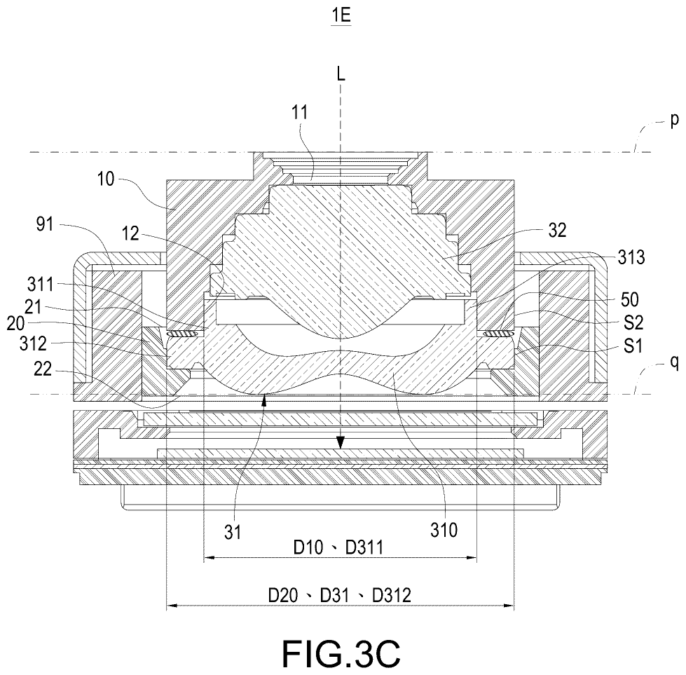

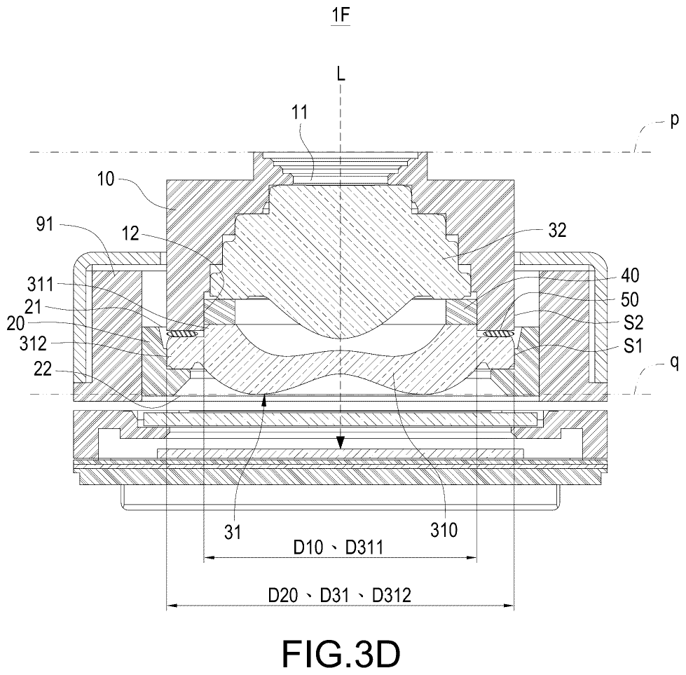

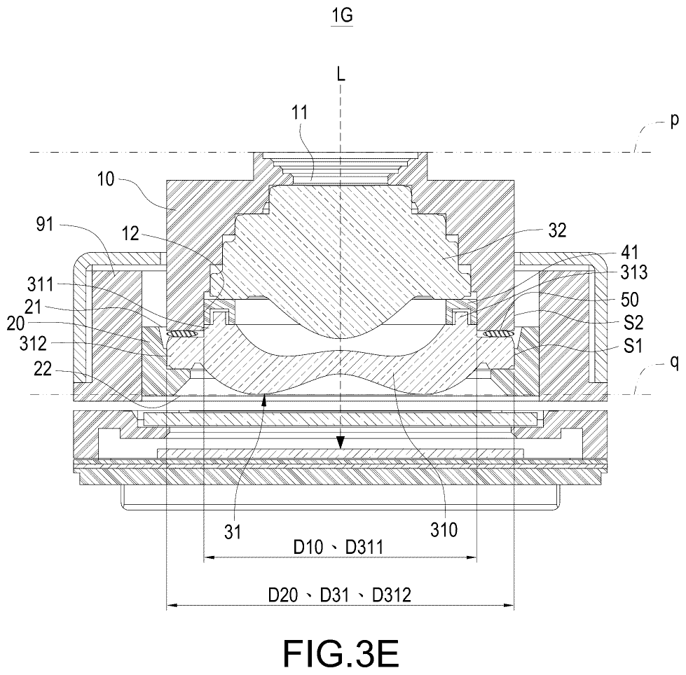

FIG. 3A is a schematic diagram of the lens miniaturization structure in accordance with an embodiment of the present disclosure. Please refer to FIG. 3A, in some embodiments, the lens miniaturization structure 1C, further includes an actuator bracket 20 abutting against the first lens 31 or the lens tube 10. An actuator 91, also known as an activator, an operating component, a driver, or a driving component, is a device that converts energy into mechanical kinetic energy and may be controlled through a processor to drive an object to perform various default actions. The actuator 91 may be, for example, a voice coil motor (VCM). The voice coil motor. The main principle of the voice coil motor is that: in a permanent magnetic field, the magnetic force is adjusted through changing the DC current of the coil in a motor, so that the spring leaf in the voice coil motor is stretched. As a result, the position of the lens tube 10 is adjusted. In some embodiments, the actuator bracket 20 may be connected to the actuator 91, and a positioning diameter D20 abutting against the outer edge S2 of the lens tube 10 to drive the first lens 31 and the lens tube 10 to move and focus. In some embodiments, the actuator bracket 20 may be connected to the actuator 91, and the positioning diameter D20 abutting against the outer edge S1 of the first lens 31 to drive the first lens 31 and the lens tube 10 to move and focus. The actuator may be an open-loop actuator or a closed-loop actuator. The actuator may have an optical image stabilization function.

In some embodiments, the actuator bracket 20 includes a first surface 21 facing the first side p and a second surface 22 facing the second side q. The second surface 22 protrudes beyond a surface of the second side q of the first lens 31. The actuator 91 and the actuator bracket 20 may drive the lens tube 10 and the first lens 31 to move, for example, to the down direction in FIG. 3A. The second surface 22 of the actuator bracket 20 protrudes beyond a surface of the second side q of the first lens 31. Therefore, the first lens 31 may be prevented from collision and wear with other components of the camera module, for example, the first lens 31 may be prevented from collision and wear with the filter element. In some embodiments, when the lens tube 10 exists alone, such as when the lens tube 10 is placed on the desktop since the second surface 22 of the actuator bracket 20 protrudes beyond the surface of the second side q of the first lens 31, the first lens 31 may be prevented from collision and wear with the desktop. In other words, the second surface 22 of the actuator bracket 20 protrudes beyond the surface of the second side q of the first lens 31 for the actuator bracket 20 protects the first lens 31.

In some embodiments, the lens miniaturization structure 1C further includes a gasket 40 sandwiched between the first lens 31 and the second lens 32. The gasket 40 may be, for example, a ring with fixed thickness, a circle ring with fixed thickness, an ellipse ring with fixed thickness, a square column with fixed thickness, a rectangular column with fixed thickness, or a cylinder with fixed thickness to position the distance between the first lens 31 and the second lens 32 to meet the structural requirements of the optical design. In some embodiments, the gasket 40 is sheathed in the lens tube 10 to position the distance between the first lens 31 and the second lens 32, and to position the gasket 40 within the lens tube 10. Therefore, the structure may be more stable.

In summary, the actuator bracket 20 of the lens miniaturization structure 1C of this embodiment may drive the first lens 31 and the lens tube 10 to move and focus. Moreover, the actuator bracket 20 may protect the first lens 31. The gasket 40 may make the structure of the lens miniaturization structure 1C more stable.

FIG. 3B is a schematic diagram of the lens miniaturization structure in accordance with an embodiment of the present disclosure. Please refer to FIG. 1 and FIG. 3A, the lens miniaturization structure 1D of this embodiment includes the first side p and the second side q located opposite to the first side p. The lens miniaturization structure 1D includes the first lens 31, the actuator bracket 20, the lens tube 10, and the second lens 32.

The first side p may face the object to be photographed. The object to be photographed may directly emit the light L or reflect the light L. In other words, the first side p may be the side where the object to be photographed is located, which may also be called the object side.

The second side q is located opposite to the first side p. The second side q may face the sensing element 94. The second side q may receive the light L directly emitted through the object to be photographed at the first side p or the light L reflected through the object to be photographed at the first side p. The object to be photographed is imaged on the second side q. The second side q may also be called an image side. The first side p and the second side q may be the opposite sides of the direction of the optical axis of the lens tube 10.

A first lens 31 includes a main body 310. The main body 310 includes a first protrusion edge 311 and a second protrusion edge 312. The second protrusion edge 312 is disposed protrusively on an edge of a main body 310. The first protrusion edge 311 is disposed adjacent to a second protrusion edge 312 and protrudes towards the first side p. An outer diameter D311 of the first protrusion edge 311 is less than an outer diameter D312 of the second protrusion edge 312. Please view from the direction facing the FIG. 3B, the first lens 31 may be, for example, a planar lens, a spherical convex lens, a spherical concave lens, a parabolic convex lens, a parabolic concave lens, or a free-form lens, here is not intended to be limiting. Please view from the top to bottom of the FIG. 3B, the shape of the first lens 31 may be a circle, an ellipse, a square, or any curved surface, here is not intended to be limiting. The shape of the second protrusion edge 312 may be a protruding ring, a protruding circle ring, a protruding ellipse ring, a protruding square column, a protruding rectangular column, or a protruding cylinder. The first protrusion edge 311 is disposed protrusively on the edge of the main body 310. The shape of the first protrusion edge 311 may be a protruding ring, a protruding circle ring, a protruding ellipse ring, a protruding square column, a protruding rectangular column, or a protruding cylinder. The first protrusion edge 311 is disposed protrusively near the second protrusion edge 312 towards the first side p. An outer diameter D311 of the first protrusion edge 311 is less than an outer diameter D312 of the second protrusion edge 312. For example, when the first protrusion edge 311 and the second protrusion edge 312 are protruding circle rings, the diameter of the first protrusion edge 311 is less than the diameter of the second protrusion edge 312. For example, when the first protrusion edge 311 and the second protrusion edge 312 are protruding ellipse rings, the major axis of the first protrusion edge 311 is less than the major axis of the second protrusion edge 312.

An actuator bracket 20 contacts the second protrusion edge 312 of the first lens 31 to position the first lens 31. In some embodiments, the actuator bracket 20 may be connected to the actuator 91, and the positioning diameter D20 abutting against the second protrusion edge 312 of the first lens 31, to drive the first lens 31 and the lens tube 10 to move and focus.

A lens tube 10 contacts the first protrusion edge 311 of the first lens 31 to position the first lens 31. The lens tube 10 may be, for example, in a column shape and has two openings. One of the openings may be the aperture 11. The aperture 11 faces the first side p. The light L directly emitted through the object to be photographed at the first side p or the light L reflected through the object to be photographed at the first side p may pass through the aperture 11 and the opening 12 sequentially. For example, the lens tube 10 may position the first lens 31 through the opening 12 of the lens tube 10 contacting the first protrusion edge 311 of the first lens 31.

A second lens 32 is disposed in the lens tube 10 and arranged between the lens tube 10 and the first lens 31. The light L directly emitted through the object to be photographed at the first side p or the light L reflected through the object to be photographed at the first side p may pass through the second lens 32 and the first lens 31 sequentially. The second lens 32 may be, for example, a planar lens, a spherical convex lens, a spherical concave lens, a parabolic convex lens, a parabolic concave lens, a square lens, or a free-form lens, here is not intended to be limiting. Please view from the top to bottom of the FIG. 2A, the shape of the second lens 32 may be a circle, an ellipse, or any curved surface, here is not intended to be limiting.

In some embodiments, the first lens 31 includes a third protrusion edge 313 disposed protrusively on the first protrusion edge 311 towards the first side p. The third protrusion edge 313 abuts against the second lens 32. The third protrusion edge 313 may be, for example, a ring with fixed thickness, a circle ring with fixed thickness, an ellipse ring with fixed thickness, a square column with fixed thickness, a rectangular column with fixed thickness, or a cylinder with fixed thickness to position the distance between the first lens 31 and the second lens 32 to meet the structural requirements of the optical design.

In summary, the lens miniaturization structure 1D of this embodiment may reduce the overall diameter of lens tube 10, for example, the size in the left and right directions in FIG. 3B, or even the size of the lens tube of the wide-angle camera module, without degrading the optical image quality and without affecting the optical axis. When the lens miniaturization structure 1D is disposed in a cell phone, a tablet PC, a laptop, a smart camera, a monitor, or a digital camera, the lens miniaturization structure 1D may save its internal plane space. Therefore, a cell phone, a tablet PC, a laptop, a smart camera, a monitor, or a digital camera may be thin, light, short, and light or the extra space may be used to be disposed components with other functions. The actuator bracket 20 may drive the first lens 31 and the lens tube 10 to move and focus. The third protrusion edge 313 may position the distance between the first lens 31 and the second lens 32 to meet the structural requirements of the optical design.

FIG. 3C is a schematic diagram of the lens miniaturization structure in accordance with an embodiment of the present disclosure. Please refer to FIG. 3C, the first lens 31 of the lens miniaturization structure 1E includes a third protrusion edge 313 disposed protrusively on the first protrusion edge 311 towards the first side p. The third protrusion edge 313 abuts against an inner surface of the lens tube 10. The shape of a third protrusion edge 313 may be a protruding ring, a protruding circle ring, a protruding ellipse ring, a protruding square column, a protruding rectangular column, or a protruding cylinder. The third protrusion edge 313 is disposed protrusively on the first protrusion edge 311 towards the first side p. As a result, the lens tube 10 may position the first lens 31 through the opening 12 of the lens tube 10 abutting against the first protrusion edge 311 and the third protrusion edge 313 of the first lens 31.

FIG. 3D is a schematic diagram of the lens miniaturization structure in accordance with an embodiment of the present disclosure. Please refer to FIG. 3D, the actuator bracket 20 of the lens miniaturization structure 1F includes a first surface 21 facing the first side p and a second surface 22 facing the second side q. The second surface 22 protrudes beyond a surface of the second side q of the first lens 31. The actuator 91 and the actuator bracket 20 may drive the lens tube 10 and the first lens 31 to move, for example, to the down direction in FIG. 3A. The second surface 22 of the actuator bracket 20 protrudes beyond the surface of the second side q of the first lens 31. Therefore, the first lens 31 may be prevented from collision and wear with other components of the camera module, for example, the first lens 31 may be prevented from collision and wear with the filter element. In some embodiments, when the lens tube 10 exists alone, such as when the lens tube 10 is placed on the desktop since the second surface 22 of the actuator bracket 20 protrudes beyond the surface of the second side q of the first lens 31, the first lens 31 may be prevented from collision and wear with the desktop. In other words, the second surface 22 of the actuator bracket 20 protrudes beyond the surface of the second side q of the first lens 31 for actuator bracket 20 protects the first lens 31.

In some embodiments, the lens miniaturization structure 1F further includes a gasket 40 sandwiched between the first lens 31 and the second lens 32. The gasket 40 may be, for example, a ring with fixed thickness, a circle ring with fixed thickness, an ellipse ring with fixed thickness, a square column with fixed thickness, a rectangular column with fixed thickness, or a cylinder with fixed thickness to position the distance between the first lens 31 and the second lens 32 to meet the structural requirements of the optical design. In some embodiments, the gasket 40 is sandwiched between the second lens 32 and the first protrusion edge 311. In some embodiments, the gasket 40 is sheathed in the lens tube 10 to position the distance between the first lens 31 and the second lens 32, and to position the gasket 40 within the lens tube 10. Therefore, the structure may be more stable.

In summary, the actuator bracket 20 of the lens miniaturization structure 1F of this embodiment may drive the first lens 31 and the lens tube 10 to move and focus. Moreover, the actuator bracket 20 may protect the first lens 31. The gasket 40 may make the structure of the lens miniaturization structure 1F more stable.

FIG. 3E is a schematic diagram of the lens miniaturization structure in accordance with an embodiment of the present disclosure. Please refer to FIG. 3E, the lens miniaturization structure 1G further includes a third protrusion edge 313 disposed protrusively on the first lens 31 towards the first side p. The gasket 40 includes a concave structure 41 adapted to sheathe the third protrusion edge 313. The shape of the third protrusion edge 313 may be a protruding ring, a protruding circle ring, a protruding ellipse ring, a protruding square column, a protruding rectangular column, or a protruding cylinder. The third protrusion edge 313 is disposed protrusively on the first protrusion edge 311 towards the first side p. The shape of the concave structure 41 corresponds to the shape of the first protrusion edge 311. The shape of the concave structure 13 may be a concave ring-shaped structure, a concave circle ring-shaped structure, a concave ellipse ring-shaped structure, a concave square column-shaped structure, a concave rectangular column-shaped structure, or a concave cylindrical-shaped structure. The concave structure 41 is disposed concavely on the first side p and adapted to sheathe the third protrusion edge 313 to position the lens tube 10 and the first lens 31.

In some embodiments, the lens miniaturization structure 1G further includes an adhesive layer 50 disposed between the second protrusion edge 312 and the lens tube 10. The adhesive layer 50 is disposed between the first lens 31 and the lens tube 10 through dispensing glue to fix the first lens 31 and the lens tube 10. In some embodiments, the second protrusion edge 312 and an adhesive layer 50 are sandwiched between the actuator bracket 20 and the lens tube 10. The actuator bracket 20 may be connected to the actuator 91, and the positioning diameter D20 abutting against the second protrusion edge 312 of the first lens 31, to drive the first lens 31 and the lens tube 10 to move and focus.

In some embodiments, the lens miniaturization structure 1G further includes a protective film disposed on the bottom of the lens tube 10 or the bottom of the first lens 31 to prevent the lens miniaturization structure 1G from scratches during manufacturing or shipping.

In summary, the lens miniaturization structure of the present disclosure may reduce the overall diameter of the lens tube or even the size of the lens tube of the wide-angle camera module. The lens miniaturization structure of the present disclosure provides a variety of ways to position, stabilize, and protect the structure. Therefore, the lens miniaturization structure of this embodiment may reduce the overall diameter of the lens tube without degrading the optical image quality and without affecting the optical axis. When the lens miniaturization structure is disposed in a cell phone, a tablet PC, a laptop, a smart camera, a monitor, or a digital camera, the lens miniaturization structure may save its internal plane space. Therefore, a cell phone, a tablet PC, a laptop, a smart camera, a monitor, or a digital camera may be thin, light, short, and light or the extra space may be used to dispose components with other functions.

As used herein and not otherwise defined, the terms “substantially” and “approximately” are used to describe and account for small variations. When used in conjunction with an event or circumstance, the terms may refer to instances in which the event or circumstance occurs precisely as well as instances in which the event or circumstance occurs to a close approximation. For example, when used in conjunction with a numerical value, the terms may refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While this disclosure has been described by means of specific embodiments, numerous modifications and variations may be made thereto by those skilled in the art without departing from the scope and spirit of this disclosure set forth in the claims.

What is claimed is:

1. A lens miniaturization structure, comprising a first side and a second side located opposite to the first side, the lens miniaturization structure comprising:
a first lens;
a lens tube, disposed on the first lens and comprising an aperture and an opening disposed on a side opposite to the aperture, the aperture facing the first side, the opening facing the second side; and
a second lens, disposed in the lens tube and arranged between the aperture and the first lens;
wherein, an inner diameter of the opening of the lens tube is less than an outer diameter of the first lens.

2. The lens miniaturization structure of claim 1, wherein, the inner diameter is a largest inner diameter of the lens tube.

3. The lens miniaturization structure of claim 1, wherein, the first lens comprises:
a first protrusion edge, disposed protrusively on a side of the first lens towards the first side;
the lens tube comprises:
a concave structure, the first protrusion edge abutting against thereon.

4. The lens miniaturization structure of claim 1, wherein, the first lens comprises:
a concave structure, disposed concavely on a side of the first lens towards the second side;
the lens tube comprises:
a protrusion edge, abutting against the concave structure of the first lens.

5. The lens miniaturization structure of claim 1, further comprising:
an actuator bracket, abutting against the first lens or the lens tube.

6. The lens miniaturization structure of claim 5, wherein, the actuator bracket abuts against an outer edge of the first lens.

7. The lens miniaturization structure of claim 5, wherein, the actuator bracket comprises:
a first surface, facing the first side; and
a second surface, facing the second side;
wherein, the second surface protrudes beyond a surface of the second side of the first lens.

8. The lens miniaturization structure of claim 1, further comprising:
a gasket, sandwiched between the first lens and the second lens.

9. The lens miniaturization structure of claim 8, wherein, the gasket is sheathed in the lens tube.

10. The lens miniaturization structure of claim 1, further comprising:
an adhesive layer, disposed between the first lens and the lens tube.

11. A lens miniaturization structure, comprising a first side and a second side located opposite to the first side, the lens miniaturization structure comprising:
a first lens, comprising
a main body, comprising a first protrusion edge and a second protrusion edge, the second protrusion edge disposed protrusively on an edge of the main body, the first protrusion edge disposed adjacent to the second protrusion edge and protruding towards the first side, wherein an outer diameter of the first protrusion edge is less than an outer diameter of the second protrusion edge;
an actuator bracket, contacting the second protrusion edge of the first lens to position the first lens;
a lens tube, contacting the first protrusion edge of the first lens to position the first lens; and
a second lens, disposed in the lens tube, and arranged between the lens tube and the first lens.

12. The lens miniaturization structure of claim 11, wherein, the first lens comprises:
a third protrusion edge, disposed protrusively on the first protrusion edge towards the first side, the third protrusion edge abutting against the second lens.

13. The lens miniaturization structure of claim 11, wherein, the first lens comprises:
a third protrusion edge, disposed protrusively on the first protrusion edge towards the first side, the third protrusion edge abutting against an inner surface of the lens tube.

14. The lens miniaturization structure of claim 11, wherein, the actuator bracket comprises:
a first surface, facing the first side; and
a second surface, facing the second side;
wherein, the second surface protrudes beyond a surface of the second side of the first lens.

15. The lens miniaturization structure of claim 11, further comprising:
a gasket, sandwiched between the first lens and the second lens.

16. The lens miniaturization structure of claim 15, wherein, the gasket is sheathed in the lens tube.

17. The lens miniaturization structure of claim 16, wherein, the gasket is sandwiched between the second lens and the first protrusion edge.

18. The lens miniaturization structure of claim 17, further comprising:
a third protrusion edge, disposed protrusively on the first lens towards the first side;
wherein, the gasket comprises:
a concave structure, adapted to sheathe the third protrusion edge.

19. The lens miniaturization structure of claim 11, further comprising:
an adhesive layer, disposed between the second protrusion edge and the lens tube.

20. The lens miniaturization structure of claim 19, wherein, the second protrusion edge and the adhesive layer are sandwiched between the actuator bracket and the lens tube.
